(19) United States
(12) Patent Application Publication
(10) Pub. No.: US 2016/0222997 A1
(43) Pub. Date: Aug. 4, 2016

(54) Fastening connector

(71) Applicants: Enhao Luo, Vancouver (CA); Dakai Luo, Vancouver (CA)

(72) Inventors: Enhao Luo, Vancouver (CA); Dakai Luo, Vancouver (CA)

(21) Appl. No.: 14/612,618

(22) Filed: Feb. 3, 2015

(51) Int. Cl. F16B 2/22

(52) U.S. Cl. CPC F16B 2/22

(57) ABSTRACT

This invention is a set of fastening multilayer connectors connected together that has triangular flanges on both sides, and flat in between latitutinally or laterally. The invented connector has an inner layer and an outer layer. The inner spring steel wire 2, processed into two triangular or other shaped flanges. The outer layer 1, wraps around the inner layer, and fills the voids in the inner layer. The outer connecting member may also wrap around or suit the inner layer member. The connector is suitable to connect rigid non-metallic material parts, such as hand-made fiberglass assembly boats and watercrafts, as well as plastic assembly boats and watercrafts made by rotational molding, injection molding or blow molding. The present invention is also applicable to connect parts that are made of non-metallic materials with grooves.

### TECHNOLOGY FIELD

This invention is a set of fastening multilayer connectors connected together. The connectors have flanges on both sides and are flat in the middle. This kind of connectors is applicable to connect rigid non-metallic parts that have grooves. By snapping or inserting the connector flanges into the parts grooves, the connector can connect the two parts tightly.

### BACKGROUND TECHNOLOGIES

The parts to be connected are usually made of rigid non-metallic materials, such as fiberglass, or plastic made by rotational molding, injection molding or blow molding. These parts have grooves at the junction to connect to another piece. The connector has flanges on both sides and flat in the middle. By snapping or inserting the connector flanges into the parts grooves, the connector can connect the two parts tightly. Fiberglass product is generally handmade, so the final product is usually not as accurately made as the design; And plastic made by rotational molding, injection molding or blow molding is thermoplastic product, so the final plastic products usually deform after releasing from mold and cooling down. All these product deficiencies will lead to the difficulties of connecting the parts together tightly and perfectly. If allowing the groove tolerance to increase in the parts, it may increase the gap between the parts or the gap between the connector and groove, making it more difficult to be tightly fastened.

### DESIGN CONTENT

This invention is to provide a solution to connect or assemble parts that are lack of accuracy at its grooves at the connection. This invented connector is longitudinally flexible or bendable, and the flanges on both sides of it are transformable into any shape to suit the groove of the parts to be connected. The connector is very strong latitudinally or laterally to resist bending and tensile forces. This invention is a continuous set of fastening connectors spirally connected together. It has a strip or band looking longitudinally, and the connectors have triangular or other shaped flanges on both sides and flat in between. The connector has an inner layer and an outer layer. The inner layer of the connector is a continuous set of metal wire or strip, forming into triangular or other shaped flanges on both sides and flat in between. The outer layer of the connector is made of elastic or flexible non-metallic materials. The inner layer is placed inside the outer layer. The connector is applicable to rigid non-metallic parts that has triangular or other shaped grooves. By snapping or inserting the connector flanges into the parts grooves, the connector can connect the two parts tightly.

The inner connecting member may also be made of metal strip segments by cutting, punching, sawing into a similar spiral multilayer body.

The outer connecting member may also wrap around or suit the inner layer member.

At the flat middle part, between the outer and inner layers, more metal wire can be added in the longitudinal direction.

The inner connector can be used alone as a connector to use, and also can be used by having part of the outer layer combined together to use as a connector.

### USEFUL EFFECTS

Easy to connect to assemble or disassemble: the outer connector of the present invention is made of soft, elastic or flexible material , so it is easy to snap into grooves and to be removed.

Reduced weight: the outer connecting member of the present invention is made of soft, elastic or flexible material, so the connecting member is lighter than metal or fiberglass materials.

Gap reduction mechanism: the outer connecting member of the present invention is made of elastic or soft material, so it can form a tight connection at the connector and the parts grooves.

Reduced production cost or connector flexibility: the present invented connector can be bent easily longitudinally, so the invented connector can be used on the same connection that has the same or similar groove and the same or similar length of the connecting part, without having to make another mould or product for this connection.

### DRAWING DESCRIPTION

FIG. 1 is the cross-sectional view of the fastening connector, having the longitudinal direction going into the page.

FIG. 2 is a 3D perspective view of the inner member of the fastening connector.

FIG. 3 is a 3D perspective view of the combination of the inner and outer members of the fastening connector.

FIG. 4 is a 3D perspective view of the outer member of the fastening connector.

In which:

Point 1 is the outer member made of non-metallic soft, elastic or flexible material.

Point 2 is the inner member made of spring steel wire.

### DETAILED OPERATION METHOD

The following is an example on how to operate the fastening connector with the drawings:

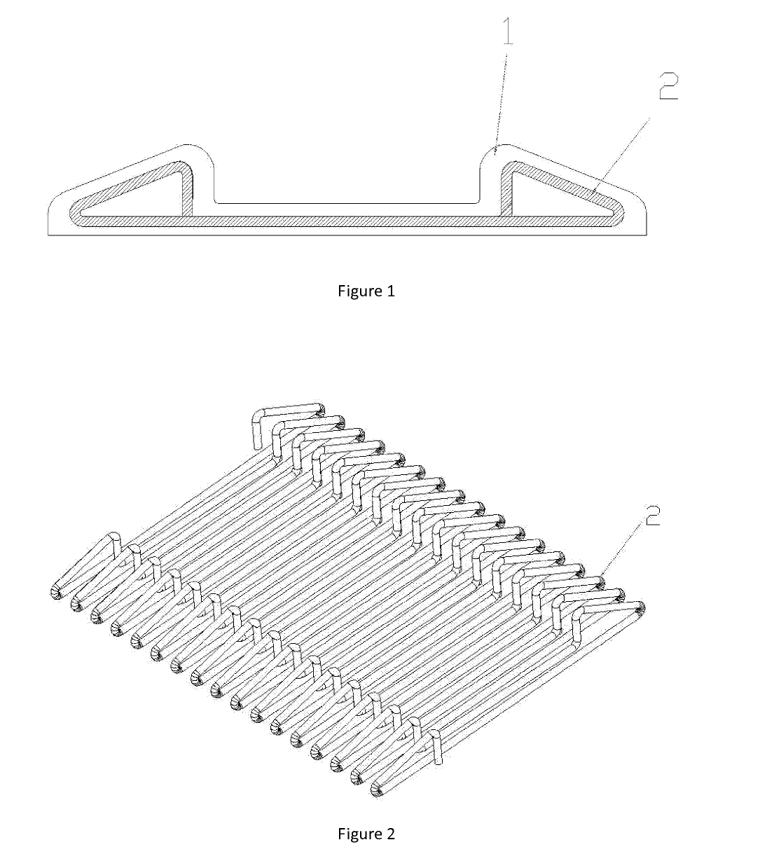

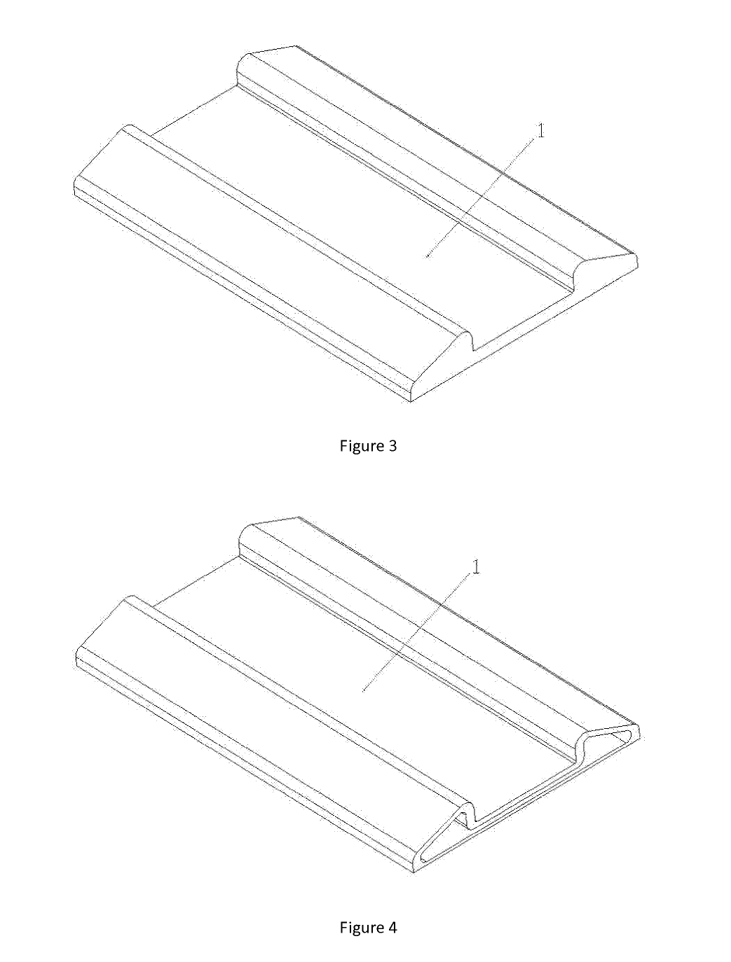

As shown in FIGS. 1 to 4, the present invention is a set of fastening connectors. The connect is strip or band looking longitudinally, and has two flanges on both sides and flat in between latitutinally or laterally. The invented connector has an inner layer and an outer layer. The inner spring steel wire 2, may also be replaced by a metal rod or a metal strip into a spiral shape, processed into two triangular or other shaped flanges. The inner layer may be made of metal processed into two side flanges, with the middle being flat, and multilayer spiral body functions made by cutting, punching, sawing, etc. The outer layer 1, is made of non-metallic soft, elastic or flexible material, or it can also be made of nylon or rubber materials. It wraps around the inner layer, and fills the voids in the inner layer. The outer connecting member may also wrap around or suit the inner layer member. At the flat middle part, between the outer and inner layers, more metal wire can be added in the longitudinal direction. The inner connector can be used alone as a connector to use, and also can be used by having part of the outer layer combined together to use as a connector.

The connector is suitable to connect rigid non-metallic material parts, such as hand-made fiberglass assembly boats and watercrafts, as well as plastic assembly boats and watercrafts made by rotational molding, injection molding or blow molding. Examples are: assembly kayak, assembly rowboat and assembly stand up board which have triangular grooves at their connecting parts, and require the use of fastening bands to assemble separated pieces together.

The present invention is also applicable to connect parts that are made of non-metallic materials with grooves.

1. This invention is a set of fastening multilayer connectors connected together that has triangular flanges on both sides, and flat in between, which has the following characteristics: the connector includes an inner layer and an outer layer, with the inner layer being metal wire, or strip formed in a spiral multilayer formation in triangular shape, and flat in between, and with the outer layer made of non-metallic soft, elastic or flexible material, and fills the void in the inner layer; this invention is applicable to connect separated parts that are made by rigid non-metallic materials, which the parts have triangular grooves at the connection; by snapping into or inserting the fastening connector into the parts grooves, the separated parts can be connected tightly.

2. According to fastening connector describes in 1, it may also be made of metal strip or band by cutting, punching, sawing into a similar spiral multilayer body.

3. According to fastening connector describes in 1, The outer connecting member may also wrap around or suit the inner layer member.

4. According to fastening connector describes in 1, at the flat middle part, between the outer and inner layers, more metal wire can be added in the longitudinal direction.

5. According to fastening connector describes in 1, the inner connector can be used alone as a connector to use, and also can be used by having part of the outer layer combined together to use as a connector.
